(19) United States
(12) Patent Application Publication
(10) Pub. No.: US 2011/0189327 A1
(43) Pub. Date: Aug. 4, 2011

(54) MOLDING MACHINE

(75) Inventors: Yoichiro KOJIMA, Toyota-shi (JP); Masanori OGAWA, Toyota-shi (JP); Hideki NISHIJIMA, Toyota-shi (JP)

(73) Assignee: KOJIMA PRESS INDUSTRY CO., LTD., Tovota-shi (JP)

(21) Appl. No.: 12/979,866

(22) Filed: Dec. 28, 2010

(30) Foreign Application Priority Data
Feb. 1, 2010 (JP) 2010-020101

(51) Int. Cl. B29C 43/00

(52) U.S. Cl. 425/193

(57) ABSTRACT

A molding machine includes a plurality of operating die units that are arranged in series while die opening/closing directions of the operating die units are respectively matched with each other. The operating die units can be closed and opened by a common drive source. The molding machine may further include a plurality of replacement die units that are respectively positioned adjacent to the operating die units and are arranged in a direction perpendicular to the die opening/closing directions of the operating die units, and support bases that are capable of moving the replacement die units to die operating positions in which the replacement die units can be closed and opened by the drive source. The support bases are capable of moving the operating die units in the direction perpendicular to the die opening/closing directions thereof and to shift the same in positions different from original positions of the replacement die units.

This application claims the benefit of priority to Japanese application no. 2010-020101 filed Feb. 1, 2010, the content of which is hereby incorporated by reference in its entirety for all purposes.

### STATEMENT REGARDING FEDERALLY SPONSORED RESEARCH OR DEVELOPMENT

Not applicable.

### BACKGROUND OF THE INVENTION

1. Field of Invention

Embodiments of the invention relate to a molding machine in which a plurality of pairs of dies (a plurality of die units) are arranged in series while die opening/closing directions of the die units are respectively matched with each other and in which die closing and opening operations of the die units can be performed by a common drive source.

A known molding machine is disclosed in Japanese Laid-Open Patent Application No. 2000-15496.

2. Background of Technology

In recent years, there is a strong desire for production of small batches of a variety of products. However, a dedicated equipment only have a limited availability factor. When a general purpose equipment is used, dies can be replaced with another dies in a single molding machine. Therefore, it is possible to perform a plurality of different molding operations in the single molding machine, thereby achieving an increased availability factor.

Generally, a replacing operation of the dies is a time consuming work. This may lead to reduced production efficiency. Thus, there is a need in the art for an improved molding machine.

### BRIEF SUMMARY OF EMBODIMENTS OF THE INVENTION

For example, in one embodiment of the invention, a molding machine includes a plurality of operating die units that are arranged in series while die opening/closing directions of the operating die units are respectively matched with each other. The operating die units can be closed and opened by a common drive source. The molding machine may further include a plurality of replacement die units that are respectively positioned adjacent to the operating die units and are arranged in a direction perpendicular to the die opening/closing directions of the operating die units, and support bases that are capable of moving the replacement die units to die operating positions in which the replacement die units can be closed and opened by the drive source. The support bases are capable of moving the operating die units in the direction perpendicular to the die opening/closing directions thereof and to shift the same in positions different from original positions of the replacement die units.

According to an embodiment of the invention, the replacement die units can be easily and quickly moved to the die operating positions in which the replacement die units can be closed and opened by the drive source. At this time, the operating die units can be removed from the dir operating positions. That is, the operating die units can be easily and quickly replaced with new operating die units. Thus, production efficiency using the molding machine can be increased.

Other objects, features and advantage of the inventions will be readily understood after reading the following detailed description together with the accompanying drawings and the claims.

### BRIEF DESCRIPTION OF THE DRAWINGS

FIG. 1 is a front view of a molding machine according to an embodiment of the invention;

FIG. 2 is a side view of the molding machine;

FIG. 3 is an operational explanatory view of an automatic conveyance device used in the molding machine;

FIG. 4 is an operational explanatory view similar to FIG. 3, illustrating an operating state different from that of FIG. 3;

FIG. 5 is an operational explanatory view similar to FIG. 3, illustrating an operating state different from that of FIG. 3;

FIG. 6 is an operational explanatory view similar to FIG. 3, illustrating an operating state different from that of FIG. 3;

FIG. 7 is an explanatory view of a molding machine according to an embodiment of the invention;

FIG. 8 is an explanatory view similar to FIG. 7, illustrating an operating state different from that of FIG. 7;

FIG. 9 is an explanatory view similar to FIG. 7, illustrating an operating state different from that of FIG. 7;

FIG. 10 is an explanatory view similar to FIG. 7, illustrating an operating state different from that of FIG. 7;

FIG. 11 is a front view of a molding machine according to an embodiment of the invention; and

FIG. 12 is a front view of a molding machine according to an embodiment of the invention.

### DETAILED DESCRIPTION OF EMBODIMENTS OF THE INVENTIONS

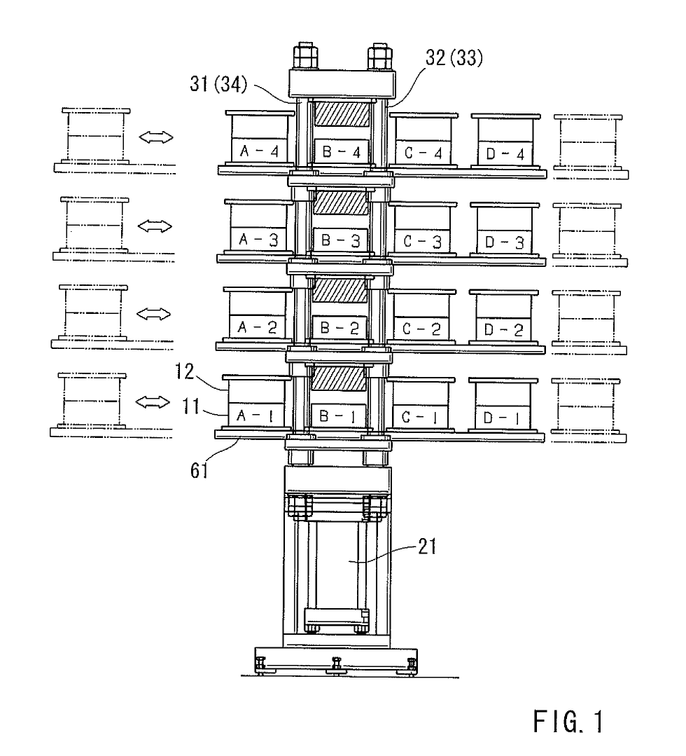

Detailed representative embodiments of the inventions are shown in FIG. 1 to FIG. 12.

Further, in the following description, embodiments of the inventions are applied to a (press) molding machine in which four pairs of dies (four die units) are arranged vertically, i.e., in a die opening/closing direction, in series. Further, upward and downward directions in the drawings respectively correspond to the die opening/closing direction. Further, with regard to a plurality of members (e.g., the dies) that have the same structures as each other, only one of them is indicated by a reference numeral as a representative one.

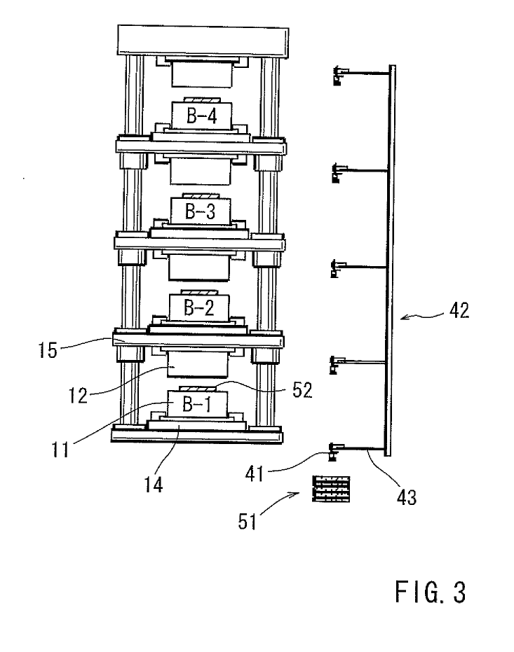

As shown in FIG. 1, a molding machine of the first embodiment includes a first set of four pairs of dies (which will be hereinafter referred to as a first set of four die units A-1, B-1, C-1 and D-1), a second set of four pairs of dies (which will be hereinafter referred to as a second set of four die units A-2, B-2, C-2 and D-2), a third set of four pairs of dies (which will be hereinafter referred to as a third set of four die units A-3, B-3, C-3 and D-3), and a fourth set of four pairs sets of dies (which will be hereinafter referred to as a fourth set of four die units A-4, B-4, C-4 and D-4). Each set of die units are arranged in series in a direction (a right and left (horizontal) direction in FIG. 1) perpendicular to a die opening/closing direction (a vertical direction in FIG. 1). Further, the first to fourth sets of die units are arranged in series in the die opening/closing direction. Each of the die units (e.g., the die unit A1) is composed of a lower die 11 and an upper die 12. In FIG. 1, the die units (B-1, B-2, B-3 and B-4) that are operated are shown by hatching, which die units will be referred to as operating die units. Further, the die units that are positioned on both sides of the operating die units are referred to as replacement die units. As shown in FIG. 1, the four sets of die units horizontally disposed in series are respectively supported on slide tables (support bases) 61 and are connected thereto via the lower dies 11 thereof. When one of the die units (e.g., the die unit B-1) disposed on the slide table 61 is positioned in a die operating position, the slide table 61 can be fixed in position by a fixing device (not shown), so that the operating die unit can be prevented from moving in directions other than the vertical direction. Further, the molding machine includes four support columns 31, 32, 33 and 34 that are positioned to confine the four operating die units. As best shown in FIG. 3, the lower die 11 of each of the operating die units is positioned on a lower die plate 14. Conversely, the upper die 12 of each of the operation die units is connected to an upper die plate 15 while suspended therefrom.

When the lowermost die plate 14 is moved upwards by a drive source 21, the lower die 11 and the upper die 12 of the operating die unit (e.g., the die unit B-1) of the first (lowermost) set of die units A-1, B-1, C-1 and D-1 contact each other, so that the operating die unit (the die unit B-1) can be closed. Subsequently, the lower dies 11 and the upper dies 12 of the operating die units (the die units B-2 to B-4) of the second to fourth set of die units are successively contact each other, so that the operating die units (the die units B-2 to B-4) can be successively closed. Upon completion of closing of the operating die unit (the die unit B-4) of the fourth (uppermost) set of die units A-4, B-4, C-4 and D-4, all of the operating die units (the die units B1 to B4) vertically arranged in series can be closed in this order. Thus, a die closing operation of the operating die units (the die units B1 to B4) can be completed. Further, the die plates 14 and 15 corresponding to these operating die units are respectively moved while guided by the support columns 31, 32, 33 and 34, so that the operating die units can be smoothly operated. In order to open the operating die units (the lower dies 11 and the upper dies 12), the drive source 21 is actuated in a reverse direction. Upon actuation of the drive source 21, the lower die 11 and the upper die 12 of the operating die unit (the die unit B-4) of the fourth (uppermost) set of die units A-4, B-4, C-4 and D-4 is separated from each other, so that the operating die unit (the die unit B-4) can be opened. Thereafter, the lower dies 11 and the upper dies 12 of the operating die units (the die units B-3 to B-1) of the remaining (third to first) sets of die units are successively separated from each other, so that the operating die units (the die units B-3 to B-1) can be opened in this order. Further, stopper members (not shown) are attached to the support columns 31, 32, 33 and 34, so that the die plate 15 of each of the operating die units can be stopped at a position shown in FIG. 1.

Each slide table 61 is supported by a support member (not shown). Further, as previously described, the horizontally disposed four die units of each of the first to fourth sets of die units are supported by the slide table 61. Therefore, when the lower die 11 of the operating die unit is operated by the drive source 21, the lower dies 11 of the remaining three die units can be moved in synchrony. Naturally, the four die units of each of the first to fourth sets of die units can be arranged and constructed such that the lower dies 11 of the remaining three die units can be prevented from being moved when the lower die 11 of the operating die unit is operated by the drive source 21.

The molding machine of this embodiment can be used to successively manufacture molded articles via a four-stage molding process. For example, in order to manufacture molded articles using the die units B-1 to B-4, the die units B-1 to B-4 are vertically arranged in this order from below while each of the die units B-1 to B-4 is positioned in the die operating position (FIG. 1). The die units B-1 to B-4 are respectively moved by moving the corresponding slide tables 61. Further, the slide tables 61 are constructed to be moved in synchrony using a common drive source. However, the slide tables 61 can respectively be provided with drive sources, so as to be moved independently from each other.

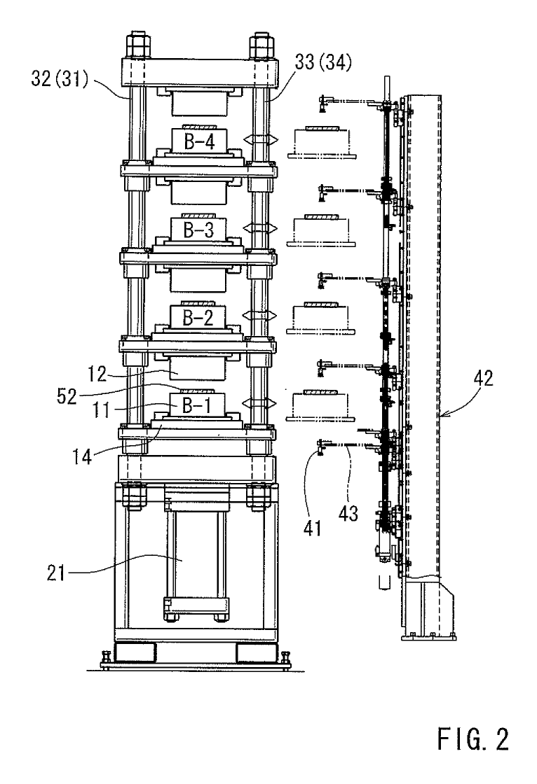

As will be recognized, in order to manufacture the molded articles using the die units B-1 to B-4, half-processed molded articles (works) 52 must be successively conveyed from the die unit B-1 to the die unit B-4 via the die units B-2 and B-3. The works 52 can be conveyed by hand. However, in this embodiment, the works 52 may preferably be conveyed using an automated conveyance device 42 (FIGS. 2 to 6).

As shown in FIG. 2, the conveyance device 42 is vertically situated on a right side (a back side in FIG. 1) of the operating die units (the die units B-1 to B-4) surrounded by the support columns 31 to 34. The conveyance device 42 has five (first to fifth) chucks 41 that are vertically separately positioned. Each of the chucks 41 may preferably be a suction chuck using a negative pressure suction force. That is, each of the chucks 41 can hold and release the work by controlling the negative pressure suction force. Further, as shown in FIG. 2, the lower die 11 of each of the operating die units is constructed to be slid and projected toward the conveyance device 42 in a die opening condition. At this time, the lower die 11 of each of the operating die units can be slid along a slide table or support base (not shown) similar to the slide table 61. As shown in FIGS. 2 to 6, the chucks 41 are laterally supported by support arms 43 which function as negative pressure supply paths communicating between a negative pressure supply source (not shown) and the chucks 41.

Next, an operation of the molding machine will now be described with reference to FIGS. 3 to 6.

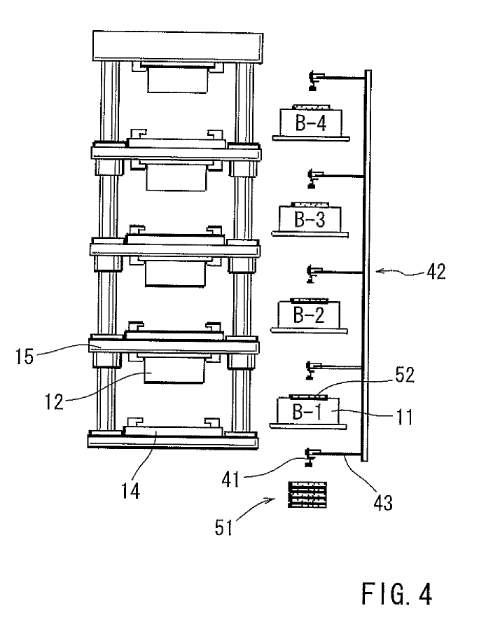

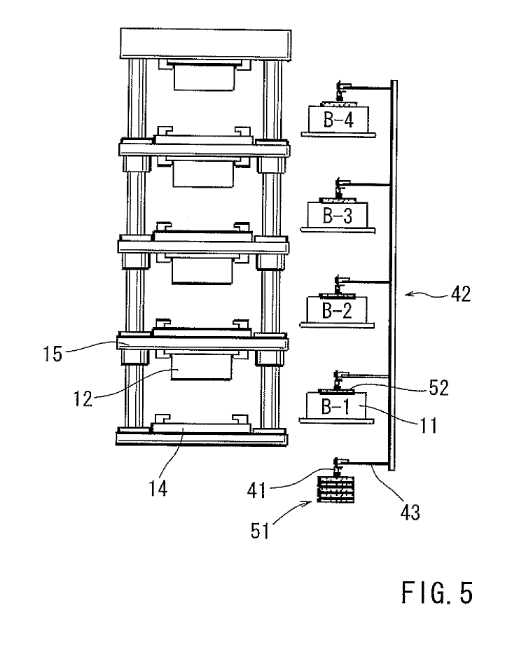

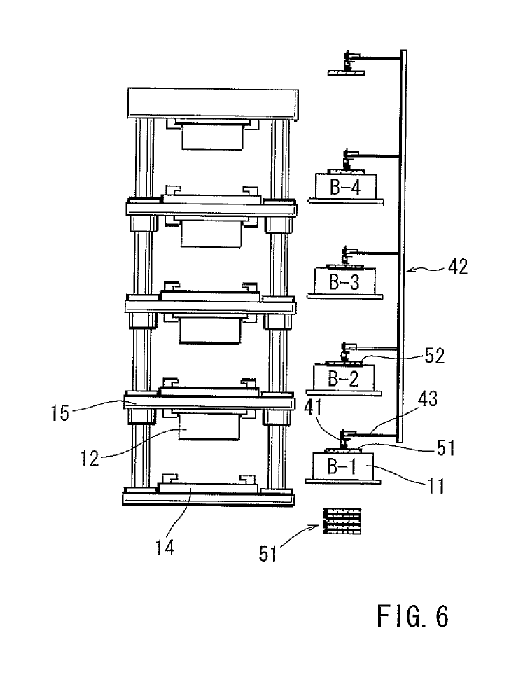

For example, in order to manufacture the molded articles using the die units B-1 to B-4 (which will be hereinafter referred to the operating die units B-1 to B-4), each of the die units B-1 to B-4 is moved to the die operating position. Thereafter, the drive source 21 is actuated in the reverse direction, so that all of the operating die units B-1 to B-4 can be opened (FIG. 3). Next, as shown in FIG. 4, the lower die 11 of each of the operating die units B-1 to B-4 is projected toward the conveyance device 42 in the die opening condition. At this time, the conveyance device 42 is maintained in a lowered position. Thereafter, as shown in FIG. 5, all of the chucks 41 (the conveyance device 42) are lowered and are actuated. As a result, the four (second to fifth) chucks 41 respectively hold the works 52 positioned on the lower dies 11 of the operating die units B-1 to B-4. Conversely, the lowermost (first) chuck 41 holds a flat plate-shaped material 51. Subsequently, as shown in FIG. 6, the conveyance device 42 is shifted to a lifted position such that the first to fourth chucks 41 respectively correspond to the lower dies 11 of the operating die units B-1 to B-4. In this condition, the five chucks 41 are deactuated to release the material 51 or the works 52. As a result, the material 51 released from the first chuck 41 is positioned on the lower die 11 of the operating die units B-1. Simultaneously, the works 52 released from the second to fourth chucks 41 are respectively positioned on the lower dies 11 of the operating die units B-2 to B-4. Further, the work 52 (the molded article) released from the uppermost (fifth) chuck 41 can be positioned on a carrier device (not shown), so as to be transferred to a next station. Thereafter, all of the chucks 41 (the conveyance device 42) are moved upwardly. Further, the lower die 11 of each of the operating die units B-1 to B-4 is contracted so as to be positioned below the corresponding upper die 12. In this condition, the drive source 21 is actuated in a normal direction, so that all of the operating die units B-1 to B-4 can be closed. Thus, a first stage of the (four-stage) molding process by the operating die unit B-1 can be performed. At the same time, second to fourth stages of the molding process by the operating die units B-2 to B-4 can be performed. Upon completion of the fourth stage of the molding process, the molded article can be produced. The molded article thus obtained may be referred to as a product B.

Subsequently, the operation described above is repeated. Thus, the molded articles (the products B) can be successively manufactured.

Further, the chucks 41 are moved laterally (back and forth in FIGS. 2 to 6) when the conveyance device 42 is moved vertically. Therefore, when the conveyance device 42 is moved vertically, the chucks 41 can be effectively prevented from being interfered with the projected lower dies 11. However, instead of moving the chucks 41 laterally when the conveyance device 42 is moved vertically, the lower dies 11 of the operating die units B-1 to B-4 can be moved (contracted) toward the die operating positions such that the chucks 41 can be prevented from being interfered with the projected lower dies 11.

As will be recognized, in order to manufacture the molded articles using the remaining die units A-1 to A-4, C-1 to C-4 or D-1 to D-4, the die units A-1 to A-4, C-1 to C-4 or D-1 to D-4 are moved to the die operating positions. Thereafter, the same operation as the operation described above is performed. Further, the molded articles thus manufactured may respectively be referred to as a product A, a product C and a product D.

In order to replace the operating die units with the other die units (e.g., replace the operating die units B-1 to B-4 with the die units A-1 to A-4), the drive source 21 is actuated in the normal direction, so as to move the die plates 14 (the lower dies 11) of the operating die units B-1 to B-4 upwardly toward the die plates 15 (the upper dies 12) thereof, thereby closing all of the operating die units B-1 to B-4. In this condition, the upper dies 12 of the operating die units B-1 to B-4 are disconnected from the die plates 15. Subsequently, the drive source 21 is actuated in the reverse direction, so as to move the die plates 14 (the lower dies 11) of the operating die units B-1 to B-4, thereby opening all of the operating die units B-1 to B-4. At this time, the operating die units B-1 to B-4 can respectively be positioned on the slide tables 61. Thereafter, the slide tables 61 are respectively slid laterally (rightwardly in FIG. 1), so that the die units A-1 to A-4 can be positioned on the die operating positions. Subsequently, the drive source 21 is actuated in the normal direction, so as to close all of the die units A-1 to A-4. In this condition, the upper dies 12 of the die units A-1 to A-4 are connected to the die plates 15. Thereafter, the drive source 21 is actuated in the reverse direction, so as to open all of the die units A-1 to A-4. Thus, the operating die units B-1 to B-4 are replaced with the die units A-1 to A-4, so that the die units A-1 to A-4 can be used as the operating die units.

Further, in the molding machine of the first embodiment, the die units can be opened and closed vertically. However, the molding machine of the first embodiment can be modified such that the die units can be opened and closed horizontally provided that the die units can be reliably connected to the die plates.

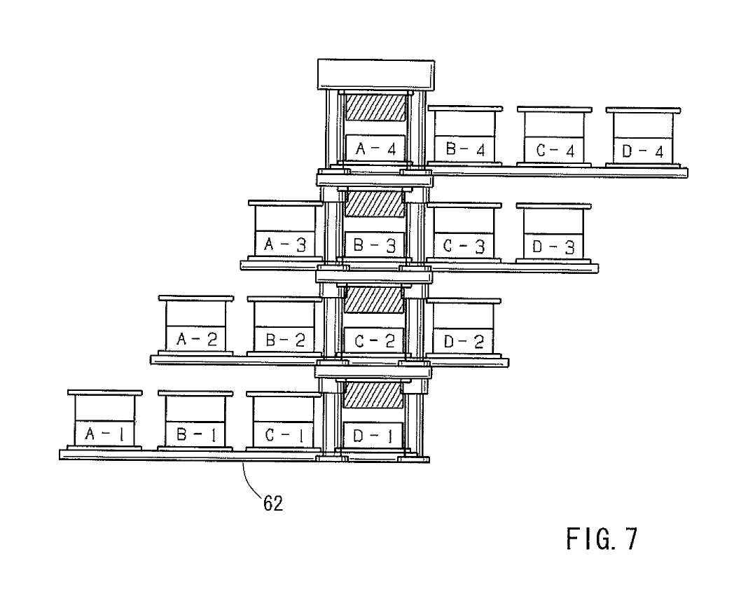

Another embodiment is described with reference to FIGS. 7 to 10.

Because the embodiment relates to the prior embodiment, only the constructions and elements that are different from the prior embodiment will be explained in detail. Elements that are the same in the prior embodiments will be identified by the same reference numerals and a detailed description of such elements may be omitted.

In this embodiment, the four sets of die units horizontally disposed in series are respectively supported on and fixed to slide tables 62. Unlike the slide tables of the first embodiment, the slide tables 62 respectively have separate drive sources, so as to be moved independently from each other.

According to this embodiment, the first set of four die units A-1, B-1, C-1 and D-1, the second set of four die units A-2, B-2, C-2 and D-2, the third set of four die units A-3, B-3, C-3 and D-3, and the fourth set of four die units A-4, B-4, C-4 and D-4 can be moved independently from each other. As a result, each of the operating die units can be independently changed. Therefore, the different molded articles can be manufactured in turns.

For example, in order to manufacture the different molded articles (the products A to D) in turns, as shown in FIGS. 7 to 10, arrangement of the operating die units is changed for each closing operation of the operating die units. In particular, as shown in FIG. 7, the die units D-1, C-2, B-3 and A-4 are positioned in the die operating positions. In this condition, the operating die units D-1, C-2, B-3 and A-4 thus positioned are closed. Thus, a first stage of the molding process by the operating die unit D-1 can be performed. At the same time, a second stage of the molding process by the operating die unit C-2, a third stage of the molding process by the operating die unit B-3 and a fourth stage of the molding process by the operating die unit A-4 can respectively be performed. Upon completion of the fourth stage of the molding process by the operating die unit A-4, the molded article (the product A) can be formed.

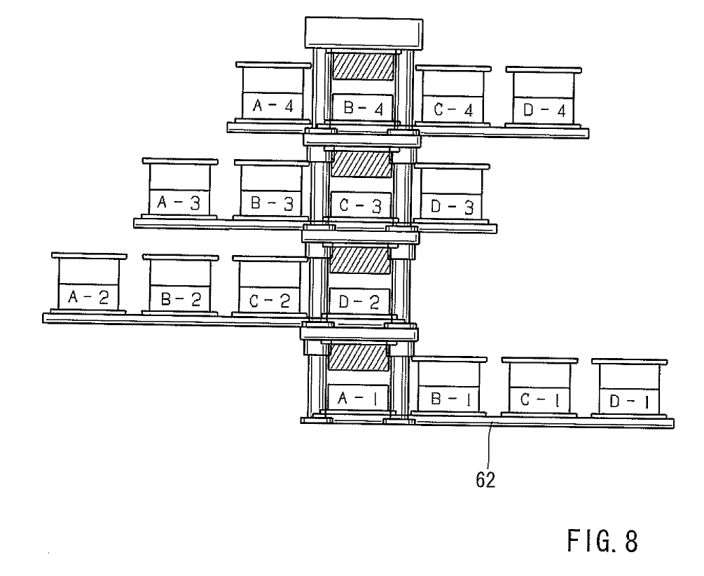

Next, as shown in FIG. 8, the operating die units D-1, C-2, B-3 and A-4 are respectively replaced with the die units A-1, D-2, C-3 and B-4. Thereafter, the new operation die units A-1, D-2, C-3 and B-4 are closed. Thus, a first stage of the molding process by the operating die unit A-1 can be performed. At the same time, a second stage of the molding process by the operating die unit D-2, a third stage of the molding process by the operating die unit C-3 and a fourth stage of the molding process by the operating die unit B-4 can respectively be performed. Upon completion of the fourth stage of the molding process by the operating die unit B-4, the molded article (the product B) can be formed.

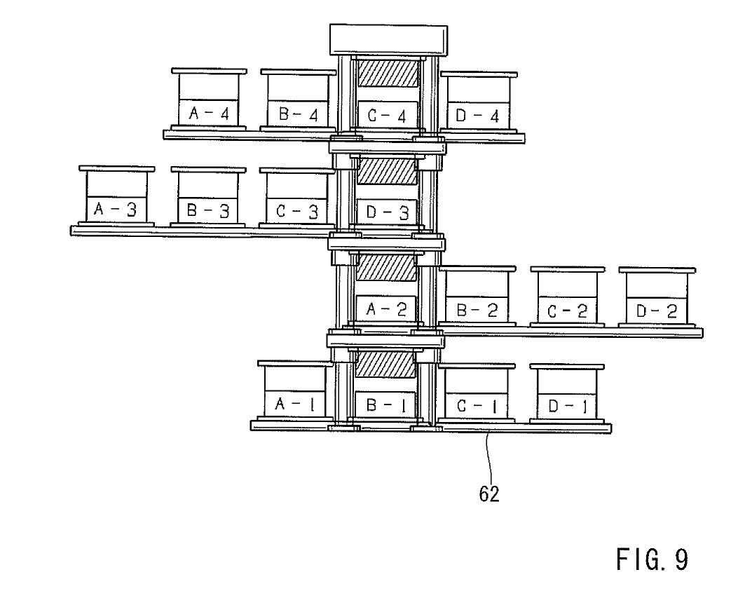

Thereafter, as shown in FIG. 9, the operating die units A-1, D-2, C-3 and B-4 are respectively replaced with the die units B-1, A-2, D-3 and C-4. Thereafter, the new operation die units B-1, A-2, D-3 and C-4 are closed. Thus, a first stage of the molding process by the operating die unit B-1 can be performed. At the same time, a second stage of the molding process by the operating die unit A-2, a third stage of the molding process by the operating die unit D-3 and a fourth stage of the molding process by the operating die unit C-4 can respectively be performed. Further, upon completion of the fourth stage of the molding process by the operating die unit C-4, the molded article (the product C) can be formed.

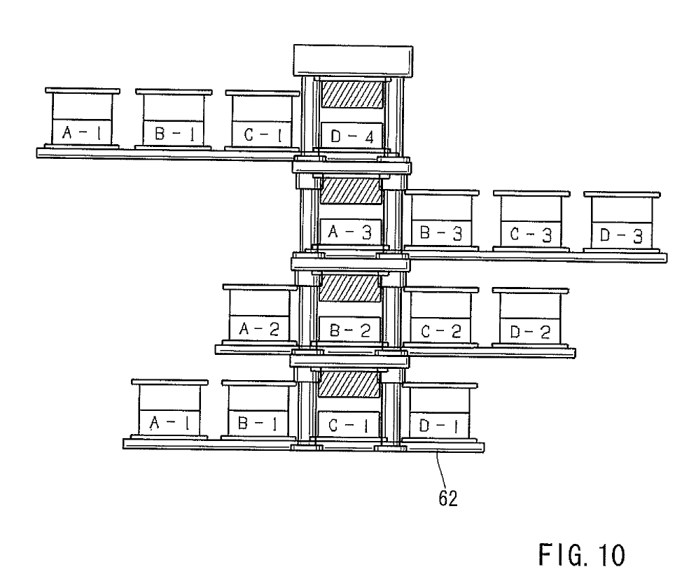

Further, as shown in FIG. 10, the operating die units B-1, A-2, D-3 and C-4 are respectively replaced with the die units C-1, B-2, A-3 and D-4. Thereafter, the new operation die units C-1, B-2, A-3 and D-4 are closed. Thus, a first stage of the molding process by the operating die unit C-1 can be performed. At the same time, a second stage of the molding process by the operating die unit B-2, a third stage of the molding process by the operating die unit A-3 and a fourth stage of the molding process by the operating die unit D-4 can respectively be performed. Further, upon completion of the fourth stage of the molding process by the operating die unit D-4, the molded article (the product D) can be formed.

Thus, the different molded articles (the products A, B, C and D) can be manufactured in turns. That is, the different molded articles can be manufactured as a set of the different molded articles.

Further, in this embodiment, all of the (four) operating die units are changed for each closing operation of the operating die units. However, one, two or three of the operating die units can be changed.

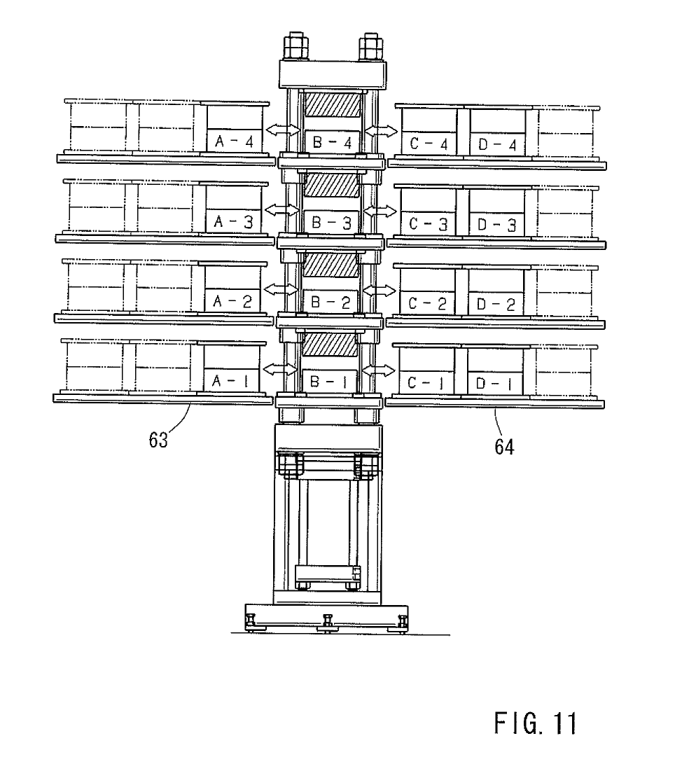

Another embodiment is described with reference to FIG. 11.

Because this embodiment relates to the prior embodiments, only the constructions and elements that are different from the prior embodiments will be explained in detail. Elements that are the same in the prior embodiments will be identified by the same reference numerals and a detailed description of such elements may be omitted.

In this embodiment, the slide tables 61 of the first embodiment and the slide tables 62 of the second embodiment are omitted. Instead, as shown in FIG. 11, the molding machine of this embodiment has four pairs of temporary placing tables or support bases 63 and 64 that positioned right and left sides of the operating die units. Each of the support tables 63 and 64 has a flat upper surface. Therefore, the die unit can be slid or moved therealong when it is pushed or pulled manually or mechanically.

Further, rollers or other such devices can be provided to the upper surface of each of the support tables 63 and 64, so that the die unit can be easily moved therealong. In addition, fixture mechanisms can be attached to each of the support tables 63 and 64, so that the die units can be fixed thereto. Further, in this embodiment, each pair of support tables 63 and 64 are linearly aligned with each other. However, each pair of support tables 63 and 64 can be inclined relative to each other, if necessary.

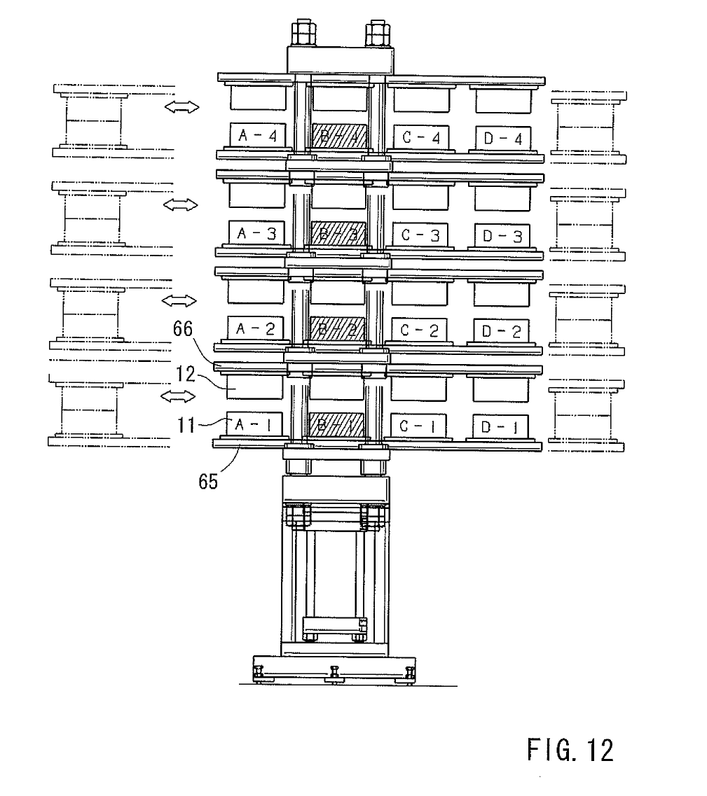

Another embodiment is described with reference to FIG. 12.

Because this embodiment relates to the prior embodiments, only the constructions and elements that are different from the prior embodiments will be explained in detail. Elements that are the same in the prior embodiments will be identified by the same reference numerals and a detailed description of such elements may be omitted.

In the prior embodiments, the lower dies of each set of four die units are respectively supported on and fixed to the slide tables 61 or the slide tables 62. Conversely, the upper dies of each set of die units are separated from each other. However, in this embodiment, as shown in FIG. 12, the lower dies 11 of each set of die units are respectively connected to a slide table (support base) 65. Conversely, the upper dies 12 of each set of die units are also respectively connected to a slide plate 66.

This means that the lower dies 11 of each set of die units (e.g., the lower dies 11 of the set of die units A-1, B-1, C-1 and D-1) are attached to a common lower die plate and that the upper dies 12 of each set of die units are attached to a common upper die plate. Therefore, when the operating die units are closed and opened, all of the four sets of die units can be closed and opened.

According to this embodiment, the operating die units can be changed while the operating die units are opened. That is, when the operating die units are replaced with the new operating die units, it is not necessary to close and open the operating die units and the replaced operating die units. Therefore, the operating die units can be easily and quickly changed. As a result, total manufacturing time of the different molded articles can be reduced.

Various changes and modifications may be made to the embodiments described above. For example, in the embodiments, the inventions are applied to the press molding machine. However, the inventions can be applied to a press cutting machine, a punching machine, an injection molding machine or other such machines. Further, when the inventions are applied to the injection molding machine, different molding materials are respectively injected in the first to fourth stages of the molding process, so as to form a laminated molded article.

Further, in the embodiments, the molding machine includes four sets of die units. Further, each set of die units include four die units. However, the molding machine can include two, three, five or more sets of die units. Similarly, each set of die units can include two, three, five or more die units. Further, respective sets of die units can include a different number of die units. For example, each of some sets of die units can include a single die unit and each of remaining sets of die units can include a plurality of die units.

Representative examples of the embodiments of the invention have been described in detail with reference to the attached drawings. This detailed description is merely intended to teach a person of skill in the art further details for practicing preferred aspects of the invention and is not intended to limit the scope of the invention. Only the claims define the scope of the claimed invention. Therefore, combinations of features and steps disclosed in the foregoing detail description may not be necessary to practice the inventions in the broadest sense, and are instead taught merely to particularly describe detailed representative examples of the inventions. Moreover, the various features taught in this specification may be combined in ways that are not specifically enumerated in order to obtain additional useful embodiments of the inventions.

1. A molding machine in which a plurality of operating die units are arranged in series while die opening/closing directions of the operating die units are respectively matched with each other and in which the operating die units can be closed and opened by a common drive source, comprising:
a plurality of replacement die units that are respectively positioned adjacent to the operating die units and are arranged in a direction perpendicular to the die opening/closing directions of the operating die units, and
support bases that are capable of moving the replacement die units to die operating positions in which the replacement die units can be closed and opened by the drive source,
wherein the support bases are capable of moving the operating die units in the direction perpendicular to the die opening/closing directions thereof and displacing the same to positions different from original positions of the replacement die units.
